(19) United States
(12) Patent Application Publication
(10) Pub. No.: US 2017/0045772 A1
(43) Pub. Date: Feb. 16, 2017

(54) LIQUID CRYSTAL DISPLAY AND METHOD OF MANUFACTURING THE SAME

(71) Applicant: Samsung Display Co. Ltd., Yongin-city (KR)

(72) Inventors: Jun Woo YOU, Seongnam-si (KR); Tae Ho LEE, Seoul (KR)

(21) Appl. No.: 15/095,976

(22) Filed: Apr. 11, 2016

(30) Foreign Application Priority Data
Aug. 11, 2015 (KR) 10-2015-0113204

(51) Int. Cl. G02F 1/1333; F21V 8/00; G02F 1/1335

(52) U.S. Cl. CPC G02F 1/133382; G02F 1/133308; G02F 1/133528; G02B 6/0073; G02F 2001/133314

(57) ABSTRACT

A liquid crystal display includes a light source, a liquid crystal panel including first and second substrates, which face each other, and liquid crystals interposed between the first and second substrates, a bottom chassis which supports the liquid crystal panel, where the light source is disposed in the bottom chassis, and a first silica aerogel layer disposed between the liquid crystal panel and the bottom chassis.

This application claims priority to Korean Patent Application No. 10-2015-0113204 filed on Aug. 11, 2015, and all the benefits accruing therefrom under 35 U.S.C. §119, the content of which in its entirety is herein incorporated by reference.

### BACKGROUND

1. Field

Exemplary embodiments of the invention relate to a liquid crystal display (“LCD”) and a method of manufacturing the LCD.

2. Description of the Related Art

A liquid crystal display (“LCD”) is one of the most widely used types of flat display device. An LCD typically includes liquid crystals inserted between two glass substrates. The LCD displays information by providing voltages to electrodes disposed on and under the glass substrates to control the orientation of the liquid crystals.

The LCD is a light-receiving device that does not self-emit light and displays an image by controlling the transmittance of light received from an external source. Therefore, the LCD includes a device for generating and irradiating light, that is, a backlight unit.

The backlight unit may provide not only light, but also heat, to the liquid crystal panel of the LCD, and as a result, the liquid crystals may be degraded. Accordingly, research is being conducted on ways to discharge heat generated inside the LCD or prevent the propagation of the heat to the liquid crystal panel of the LCD.

### SUMMARY

Exemplary embodiments of the invention provide a liquid crystal display (“LCD”) and a method of manufacturing the LCD, in which the degradation of liquid crystals by heat released from a light source is effectively prevented.

According to an exemplary embodiment of the invention, an LCD includes a light source, a liquid crystal panel including first and second substrates, which face each other, and liquid crystals interposed between the first and second substrates, a bottom chassis which supports the liquid crystal panel, where the light source is disposed in the bottom chassis, and a first silica aerogel layer disposed between the liquid crystal panel and the bottom chassis.

In an exemplary embodiment, the light source may include a light-emitting diode (“LED”)

In an exemplary embodiment, the light source and the first silica aerogel layer may overlap each other.

In an exemplary embodiment, the liquid crystal panel may include a display area and a non-display area, and at least a portion of the first silica aerogel layer may be disposed in the non-display area of the liquid crystal panel.

In an exemplary embodiment, the liquid crystal panel and the bottom chassis may be attached to each other by the first silica aerogel layer.

In an exemplary embodiment, the bottom chassis may include a bottom surface, sidewalls, which extend upwardly from the sides of the bottom surface, and a supporting surface, which is parallel to the bottom surface, and the light source may be disposed between the bottom surface and the supporting surface of the bottom chassis.

In an exemplary embodiment, the first silica aerogel layer may be disposed between the top of the supporting surface of the bottom chassis and the liquid crystal panel.

In an exemplary embodiment, the LCD may further include an upper polarizing plate disposed on the liquid crystal panel, a lower polarizing plate disposed below the liquid crystal panel, and a second silica aerogel layer disposed on at least a portion of an outer surface of the lower polarizing plate.

In an exemplary embodiment, the second silica aerogel layer may have a light transmittance of about 80% or higher.

In an exemplary embodiment, the second silica aerogel layer may comprise an ultraviolet (“UV”)-cured resin.

In an exemplary embodiment, the UV cured resin may include an acrylic functional group.

In an exemplary embodiment, the second silica aerogel layer may further include a hybrid silica aerogel represented by the following formula:

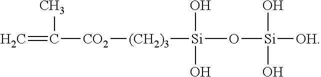

In an exemplary embodiment, the first silica aerogel layer may not overlap the lower polarizing plate.

According to an exemplary embodiment of the invention, a method of manufacturing an LCD includes preparing a light source, a bottom chassis and a liquid crystal panel of the liquid crystal display, disposing a light source of the liquid crystal display on the bottom chassis, and disposing the liquid crystal panel on the bottom chassis, and providing a first silica aerogel layer between the bottom chassis and the liquid crystal panel.

In an exemplary embodiment, the bottom chassis may include a bottom surface, sidewalls, which extend upwardly from the sides of the bottom surface, and a supporting surface, which is parallel to the bottom surface, and the disposing the light source of the liquid crystal display on the bottom chassis may include inserting the light source between the bottom surface and the supporting surface.

In an exemplary embodiment, the providing the first silica aerogel layer between the bottom chassis and the liquid crystal panel may include disposing the first silica aerogel layer between the supporting surface and the liquid crystal panel.

In an exemplary embodiment, the method may further include providing an upper polarizing plate on the liquid crystal panel, providing a lower polarizing plate below the liquid crystal panel, and forming a second silica aerogel layer on at least a portion of an outer surface of the lower polarizing plate.

In an exemplary embodiment, the forming the second silica aerogel layer may include forming the second silica aerogel layer through a sol-gel reaction between 3-methacryl trimethoxysilane (“MATS”) and tetraethyl orthosilicate (“TEOS”).

In an exemplary embodiment, the second silica aerogel layer may include a hybrid silica aerogel obtained by the sol-gel reaction, and the hybrid silica aerogel may be represented by the following formula:

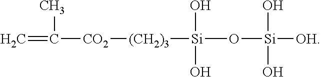

In an exemplary embodiment, the forming the second silica aerogel layer may further include using a UV-curable resin and a photo-initiator.

According to exemplary embodiments of the invention, the degradation of liquid crystals by heat released from a light source is effectively prevented.

Other features and exemplary embodiments will be apparent from the following detailed description, the drawings, and the claims.

### BRIEF DESCRIPTION OF THE DRAWINGS

The above and other features of the invention will become more apparent by describing in further detail exemplary embodiments thereof with reference to the accompanying drawings, in which:

FIG. 1 is a schematic perspective view of a liquid crystal display (“LCD”) according to an exemplary embodiment of the invention;

FIG. 2 is a cross-sectional view of the LCD of FIG. 1, taken along line I1-I1′ of FIG. 1;

FIG. 3 is a cross-sectional view of the LCD of FIG. 1, taken along line I2-I2′ of FIG. 1;

FIG. 4 is an enlarged cross-sectional view of the portion A of the LCD of FIG. 1;

FIG. 5 is an enlarged cross-sectional view of the portion B of the LCD of FIG. 1;

FIG. 6 is a cross-sectional view of an LCD according to an alternative exemplary embodiment of the invention, taken along line I1-I1′ of FIG. 1;

FIG. 7 is a cross-sectional view of an LCD according to another alternative exemplary embodiment of the invention, taken along line I1-I1′ of FIG. 1;

FIG. 8 is a cross-sectional view of an LCD according to another alternative exemplary embodiment of the invention, taken along line I1-I1′ of FIG. 1;

FIG. 9 is a cross-sectional view of an LCD according to another alternative exemplary embodiment of the invention, taken along line I2-I2′ of FIG. 1;

FIG. 10 is a plan view of the LCD of FIG. 1;

FIG. 11 is a plan view of an LCD according to another alternative exemplary embodiment of the invention; and

FIG. 12 is a plan view of an LCD according to another alternative exemplary embodiment of the invention.

### DETAILED DESCRIPTION

Features of the inventive concept and methods of accomplishing the same may be understood more readily by reference to the following detailed description of preferred embodiments and the accompanying drawings.

The inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the inventive concept will only be defined by the appended claims.

In the drawings, the thickness of layers and regions are exaggerated for clarity. It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other.

Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in detail with reference to the accompanying drawings.

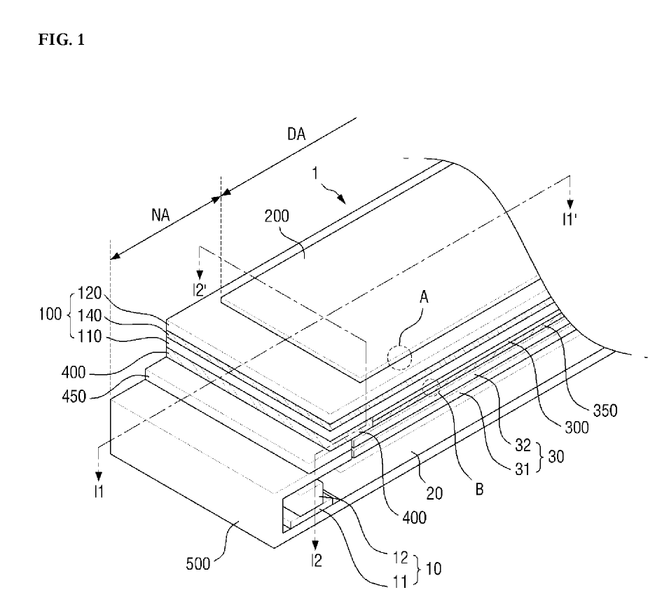

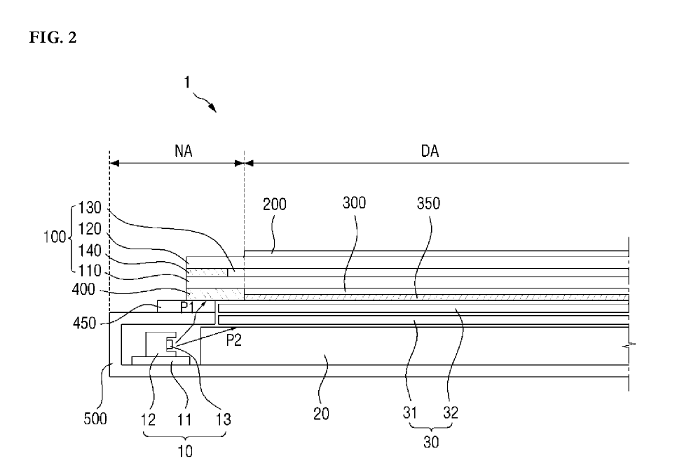

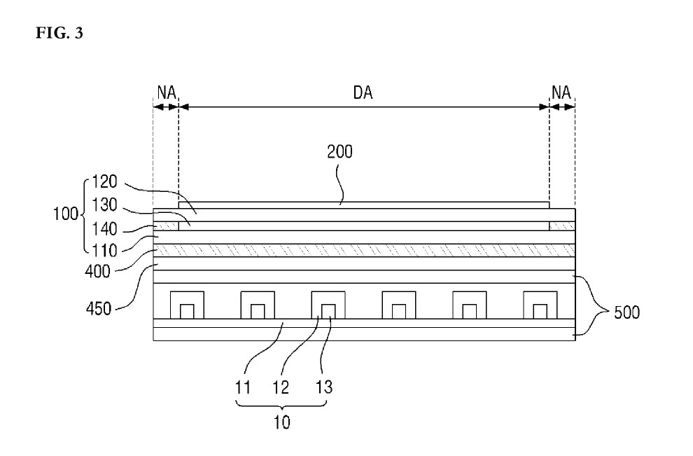

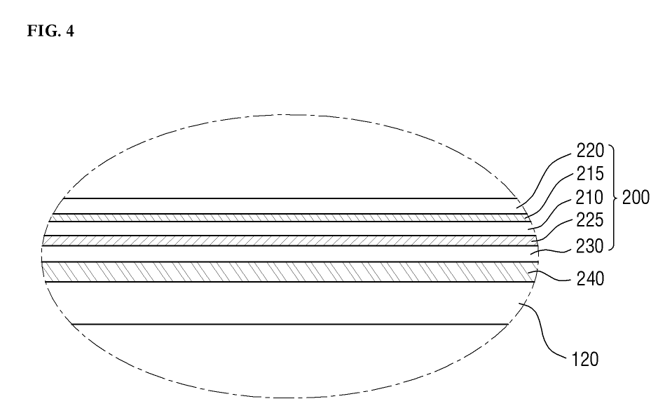

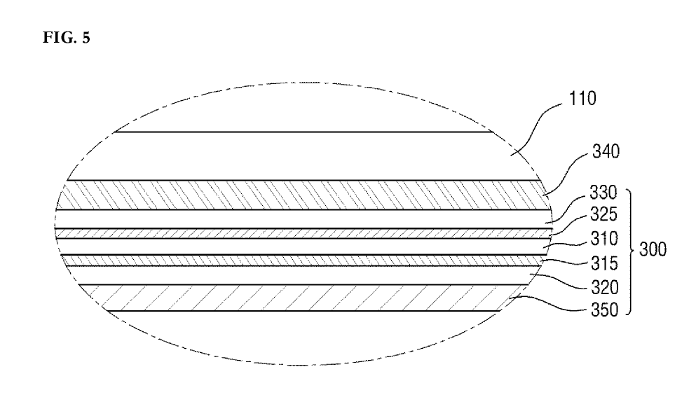

FIG. 1 is a schematic perspective view of a liquid crystal display (“LCD”) according to an exemplary embodiment of the invention, FIG. 2 is a cross-sectional view of the LCD of FIG. 1, taken along line I1-I1′ of FIG. 1, FIG. 3 is a cross-sectional view of the LCD of FIG. 1, taken along line I2-I2′ of FIG. 1, FIG. 4 is an enlarged cross-sectional view of the portion A of the LCD of FIG. 1, and FIG. 5 is an enlarged cross-sectional view of the portion B of the LCD of FIG. 1.

Referring to FIGS. 1 to 5, an exemplary embodiment of an LCD 1 includes a light source 10, a liquid crystal panel 100, which includes first and second substrates 110 and 120 that face each other with liquid crystals 130 interposed therebetween, a bottom chassis 500, which supports the liquid crystal panel 100 and accommodates and fixes the light source 10 therein, and a first silica aerogel layer 400, which is disposed in a gap between the liquid crystal panel 100 and the bottom chassis 500.

The light source 10 may include a light-emitting diode (“LED”) 13 disposed, e.g., mounted, on a printed circuit board (“PCB”) 11. In an exemplary embodiment, the light source 10 may include a plurality of LEDs 13. In an alternative exemplary embodiment, the light source 10 may include a single LED 13. The LEDs 13 may be blue LEDs, ultraviolet (“UV”) LEDs, or white LEDs. The LEDs 13 may be mounted on the PCB 11, may emit light in response to a driving signal applied thereto, and may be arranged along a side of the liquid crystal panel 100.

In an exemplary embodiment, as illustrated in FIG. 2, the LEDs 13 may be located inside a mold 12. The mold 12 may include or be formed of a reflective material and may thus change the path of light from the LEDs 13 to allow the light to travel in a predetermined direction. Although not specifically illustrated, the PCB 11 may be attached onto the bottom chassis 500 by applying a heat dissipation tape or a polyurethane resin onto the bottom surface of the PCB 11.

The bottom chassis 500 may include a bottom surface, sidewalls, which extend upwardly from the sides of the bottom surface, and a supporting surface, which is substantially parallel to the bottom surface. The bottom surface and the supporting surface may be opposite to each other. In an exemplary embodiment, as illustrated in FIGS. 1 and 2, the bottom chassis 500 may have a flat bottom surface and may be U-shaped in a side view. Accordingly, the light source 10 may be disposed, e.g., inserted and fixed, between the bottom surface and the supporting surface of the bottom chassis 500. The bottom chassis 500 may be formed of a reflective material and may thus allow light provided by the light source 10 to travel only in a predetermined direction. Light emitted toward the bottom chassis 500 from a light guide plate 20 may be reflected by the bottom chassis 500 and may thus travel toward the liquid crystal panel 100, which is disposed above the bottom chassis 500. However, the material of the bottom chassis 500 is not particularly limited. In an alternative exemplary embodiment, the bottom chassis 500 may include or be formed of a polymer, such as plastic, and a reflective material may be coated on a surface of the bottom chassis 500 in an area where the light source 10 is located.

The supporting surface of the bottom chassis 500 may completely cover the light source 10 in a plan view, e.g., when viewed from a top plan view. Accordingly, light from the light source 10 may be prevented from being transmitted to undesired parts of the LCD 1 and causing light leakage. The supporting surface may be parallel to the bottom surface, but the invention is not limited thereto. In an alternative exemplary embodiment, the supporting surface may be partially inclined, or the shape of the supporting surface may be variously modified.

The light guide plate 20 may be disposed on the bottom surface of the bottom chassis 500, and optical sheets 30 including a prism sheet 32 and a diffusion sheet 31 may be disposed on the light guide plate 20. The diffusion sheet 31 may diffuse light emitted from the light guide plate 20 and may thus provide the diffused light to the liquid crystal panel 100, and the prism sheet 32 may allow the light diffused by the diffusion sheet 31 to be collected in a direction perpendicular to a surface of the liquid crystal panel 100, which is disposed above the prism sheet 32. In an exemplary embodiment, the light guide plate 20, the diffusion sheet 31 and the prism sheet 32 may be sequentially stacked as illustrated in FIGS. 1 to 4, but the invention is not limited thereto. In an alternative exemplary embodiment, other optical sheets such as a micro-lens array film may be additionally provided, and various modifications may be made to the structure and arrangement of the optical sheets 30 without departing from the scope of the invention. In an exemplary embodiment, two or more diffusion films may be used, or two or more prism films may be used. In an exemplary embodiment, the arrangement of the optical sheets 30 may be appropriately modified by those of ordinary skill in the art according to circumstances.

The light guide plate 20 may be spaced apart from the light source 10 with a predetermined distance, and may have a surface facing the light source 10. In such an embodiment, the light source 10 may be disposed on a side of the light guide plate 20, and light provided by the light source 10 may be incident upon the side of the light guide plate 20 and may thus travel toward the liquid crystal panel 100, which is disposed above the light guide plate 20. As described above, the optical sheets 30, which are disposed on the light guide plate 20, may be for improving luminance and the uniformity of luminance, and the optical properties of the light toward the liquid crystal panel 100 may be improved by the optical sheets 30.

The light guide plate 20 may transform light incident thereupon into planar light by reflecting, refracting and scattering the incident light, and may emit the planar light. The light guide plate 20 may include or be formed of a polymethyl methacrylate resin, a polycarbonate (“PC”) resin, an acrylonitrile-styrene-butadiene copolymer resin, a polystyrene resin, an acrylonitrile-styrene copolymer resin, a polyolefin resin, or a polymethacrylate-styrene resin in which poly(methyl methacrylate) and polystyrene are mixed. The light guide plate 20 may have a wedge shape in which the thickness of the light guide plate 20 decreases as the distance from the light source 10 increases, or have a plate-like shape with the top and bottom surfaces thereof substantially parallel to each other. The shape of the light guide plate 20 may be appropriately modified by those of ordinary skill in the art according to circumstances.

In an exemplary embodiment, where the bottom chassis 500 is not formed of a reflective material, a reflection sheet (not illustrated) may be disposed between the light guide plate 20 and the bottom chassis 500, and may allow light which is emitted toward the bottom of the light guide plate 20 to travel back toward the liquid crystal panel 100, which is disposed above the light guide plate 20.

The liquid crystal panel 100 may be supported by the bottom chassis 500. In an exemplary embodiment, one side of the liquid crystal panel 100 is supported by the bottom chassis 500 as illustrated in FIGS. 1 and 2, and the other side of the liquid crystal panel 100 may be similarly supported by the bottom chassis 500. In an exemplary embodiment, where the liquid crystal panel 100 is supported by the bottom chassis 500, the liquid crystal panel 100 may be directly supported by the bottom chassis 500 or be indirectly supported by the bottom chassis 500 with other elements interposed therebetween.

The liquid crystal panel 100 may include the first and second substrates 110 and 120, which face each other, and the liquid crystals 130 may be interposed between the first and second substrates 110 and 120. The liquid crystals 130 may be encapsulated by a sealing member 140 along the sides of the first and second substrates 110 and 120.

The first substrate 110 may be a thin-film transistor (“TFT”) array substrate. Although not specifically illustrated, the first substrate 110 may include TFTs and pixel electrodes, which are field-generating electrodes including or formed of a transparent conductive oxide such as indium tin oxide (“ITO”) or indium zinc oxide (“IZO”), on a base, which includes or is formed of a transparent insulating material such as glass or plastic, and each of the TFTs may include a gate electrode, a gate insulating layer, a semiconductor layer, an ohmic contact layer and source and drain electrodes.

The second substrate 120 may be a color filter (“CF”) substrate. Although not specifically illustrated, the second substrate 120 may include a black matrix, which effectively prevents light leakage, a plurality of color filters, e.g., red, green and blue color filters, and a common electrode, which is a field-generating electrode including or formed of a transparent conductive oxide such as ITO or IZO, at the bottom of a base, which includes or is formed of a transparent insulating material such as glass or plastic.

In an exemplary embodiment, each of the first and second substrates 110 and 120 may include a plastic substrate including polyethylene terephthalate (“PET”), PC, polyimide (“PI”), polyethylene naphthalate (“PEN”), polyether sulfone (“PES”), polyarylate (“PAR”), or a cyclic olefin copolymer (“COC”) or a glass substrate, but the invention is not limited thereto. In an exemplary embodiment, the first and second substrates 110 and 120 may include or be formed of a flexible material.

In an exemplary embodiment, the liquid crystals 130 may be in a twisted nematic (“TN”) mode, a vertical alignment (“VA”) mode, or a horizontal alignment mode (such as an in-plane switching (“IPS”) mode or a fringe-field switching (“FFS”) mode), but the invention is not limited thereto.

An upper polarizing plate 200 may be disposed on the liquid crystal panel 100, and a lower polarizing plate 300 may be disposed below the liquid crystal panel 100. The transmission axes of the upper and lower polarizing plates 200 and 300 may be orthogonal or parallel to each other. The upper and lower polarizing plates 200 and 300 will be described later in detail.

At least a portion of the first silica aerogel layer 400 may be disposed on or to overlap the liquid crystal panel 100. In an exemplary embodiment, where the liquid crystal panel 100 includes a display area DA where an image is displayed and a non-display area NA around the display area DA, and the first silica aerogel layer 400 may be disposed in the non-display area NA of the liquid crystal panel 100, e.g., on a surface of the liquid crystal panel 100 facing the bottom chassis 500. In an exemplary embodiment, the first silica aerogel layer 400 may be disposed in the non-display area NA of the liquid crystal panel 100 not to overlap the liquid crystals 130, but the invention is not limited thereto. In an alternative exemplary embodiment, the first silica aerogel layer 400 may be disposed to overlap a portion of the display area DA when viewed from a top plan view.

The light source 10 and the first silica aerogel layer 400 may overlap each other. In one exemplary embodiment, for example, the first silica aerogel layer 400 may overlap the light source in a plan view. In one exemplary embodiment, for example, the first silica aerogel layer 400 may be attached onto the liquid crystal layer 100 in the form of a tape.

The LCD 1 may further include an adhesive tape 450 for bonding and fixing the bottom chassis 500 and the liquid crystal panel 100 together, as illustrated in FIGS. 1 and 2.

The first silica aerogel layer 400 may block heat from the light source 10. The first silica aerogel layer 400 may have a low thermal conductivity of about 0.1 watt per meter kelvin (W/m·K) at room temperature and have high adiabatic properties. Accordingly, the first silica aerogel layer 400 may effectively prevent the propagation of heat from the light source 10 to the liquid crystals 130.

Referring to FIG. 2, light provided by the light source 10 may travel toward the liquid crystal panel 100 through the light guide plate 20, but heat from the light source 10 may travel to the liquid crystal panel 100 along a first path P1 such that the liquid crystals 130 may be degraded and the performance of the liquid crystals 130 may be deteriorated. In an exemplary embodiment, the first silica aerogel layer 400 may block the transmission of heat along the first path P1 and may thus effectively prevent the degradation of the liquid crystals 130. In such an embodiment, where the sidewalls extends upwardly from the sides of the bottom surface of the bottom chassis 500 and the supporting surface extends from the sidewalls in parallel to the bottom surface of the bottom chassis 500 including a reflective material, light emitted from the light source 10 may travel toward the light guide plate 20, which corresponds to an opening of the bottom chassis 500. However, in such an embodiment, where heat emitted from the light source 10 is not blocked by the supporting surface of the bottom chassis 500, the first silica aerogel layer 400 is provided to effectively block the transmission of heat toward the liquid crystals 130.

In an exemplary embodiment, as illustrated in FIG. 3, a plurality of light sources 10 may be arranged at regular intervals along a side of the liquid crystal panel 100. In such an embodiment, the first silica aerogel layer 400 may extend in a direction in which the light sources 10 are arranged. In an exemplary embodiment, the first silica aerogel layer 400 may extend in one direction as illustrated in FIG. 3, but the invention is not limited thereto. Alternatively, a plurality of first silica aerogel layers 400 may be arranged at regular intervals to be spaced from one another and to correspond to the plurality of light sources 10, respectively.

In an exemplary embodiment, the first silica aerogel layer 400 may be disposed between the top of the supporting surface of the bottom chassis 500 and the liquid crystal panel 100. In such an embodiment, the first silica aerogel layer 400 may be interposed between the supporting surface of the bottom chassis 500 and the liquid crystal panel 100. As described above, the adhesive tape 450 may be disposed between the first silica aerogel layer 400 and the supporting surface of the bottom chassis 500 such that the first silica aerogel layer 400 and the bottom chassis 500 may be attached to each other.

The first silica aerogel layer 400 may not overlap the lower polarizing plate 300. In such an embodiment, the first silica aerogel layer 400 may not overlap, but may be spaced from, the lower polarizing plate 300 in a plan view, but the invention is not limited thereto. In an alternatively exemplary embodiment, the first silica aerogel layer 400 may slightly overlap the lower polarizing plate on both sides thereof. In an exemplary embodiment, a second silica aerogel layer 250 having a high light transmittance may be disposed on the lower polarizing plate 300, and the lower polarizing plate 300 and the first silica aerogel layer 400 may not overlap each other.

Referring to FIG. 4, the upper polarizing plate 200 may be attached to the top of the second substrate 120 by an adhesive 240. The upper polarizing plate 200 may include a polarizer 210 and protective films 220 and 230, which are attached onto opposing surfaces of the polarizer 210 with adhesives 215 and 225 interposed therebetween. The polarizer 210 may be a polyvinyl alcohol (“PVA”)-based film dyed or aligned with a dichroic dye or iodine, but the invention is not limited thereto. In an alternative exemplary embodiment, one of the protective films 220 and 230 may be omitted. Although not specifically illustrated, various functional layers such as a hard coating layer, a reflection prevention layer, and the like may be disposed on the protective film 230, which is on a visible side of the polarizer 210. The functional layers are already well known in the art to which the invention pertains, and thus, detailed descriptions thereof will be omitted.

Referring to FIG. 5, the lower polarizing plate 300 may be attached to the bottom of the first substrate 110 by an adhesive 340, and may include a polarizer 310 and protective films 320 and 330, which are attached onto opposing surfaces of the polarizer 310 with adhesives 315 and 325 interposed therebetween. The polarizer 310 and the protective films 320 and 330 of the lower polarizing plate 300 are the same as the polarizer 210 and the protective films 220 and 230 of the upper polarizing plate 200 described above, and thus, any repetitive detailed descriptions thereof will be omitted.

In an exemplary embodiment, the second silica aerogel layer 350 may be disposed on at least a portion of an outer surface of the lower polarizing plate 300. In such an embodiment, the second silica aerogel layer 350 may be disposed on a surface of the lower polarizing plate 300 facing the light guide plate 20 or the bottom surface of the bottom chassis 500.

Referring back to FIG. 2, as described above, heat from the light source 10 may be transmitted to the liquid crystal panel 100 along the first path P1, but may also be transmitted along the second path P2 together with light traveling toward the light guide plate 2. In an exemplary embodiment, the second silica aerogel layer 350 may be disposed on an outer surface of the lower polarizing plate 300 to block the transmission of heat to the liquid crystal panel 100 along the second path P2 and thus to effectively prevent the degradation of the liquid crystals 130.

The second silica aerogel layer 350 may have a light transmittance of 80% or higher. In one exemplary embodiment, for example, the second silica aerogel layer 350 may have a light transmittance in a range of about 80% to about 95%. In such an embodiment, where the transmittance of the second silica aerogel layer 350 is in the range of about 80% to about 95%, the reduction of the luminance of light transmitted to the liquid crystal panel 100 through the light guide plate 20 may be minimized.

In an exemplary embodiment, the second silica aerogel layer 350 may be in the form of a UV-curable resin including a silica aerogel. In such an embodiment, the UV-curable resin may include an acrylic resin, and a hybrid silica aerogel with an acrylic functional group introduced thereinto may be used as the silica aerogel for effective mixing with the acrylic resin. However, the invention is not limited to this. In an alternative exemplary embodiment, a silica aerogel having a functional group similar to the ingredients of an organic binder for UV curing introduced thereinto may be used to improve the miscibility of the silica aerogel and thus to improve the transmittance of the second silica aerogel layer 350. In an exemplary embodiment, the second silica aerogel layer 350 may include a hybrid silica aerogel represented by the following Formula:

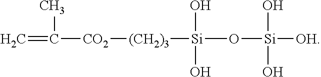

The second silica aerogel layer 350 may be fabricated using a sol-gel reaction between 3-methacryl trimethoxysilane (“MATS”) and tetraethyl orthosilicate (“TEOS”), which will be described later in detail.

In an exemplary embodiment, the second silica aerogel layer 350 may be disposed on or to overlap an entire surface of the lower polarizing plate 300, but the invention is not limited thereto. Alternatively, the second silica aerogel layer 350 may be disposed in various other manners, for example, may be provided only in an area close to the light source 10, but not in an area distant from the light source 10.

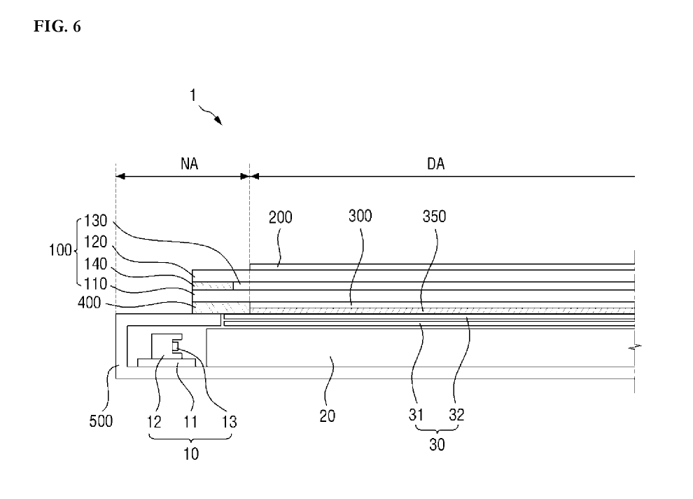

FIG. 6 is a cross-sectional view of an LCD 1 according to an alternative exemplary embodiment of the invention, taken along line I1-I1′ of FIG. 1. Referring to

FIG. 6, in an exemplary embodiment, a first silica aerogel layer 400 may be adhesive itself, and thus, a liquid crystal panel 100 and a bottom chassis 500 may be attached or bonded to each other by the first silica aerogel layer 400. The LCD 1 shown in FIG. 6 is substantially the same as the LCD 1 shown in FIG. 2 except for the adhesive tape 450. The same or like elements shown in FIG. 6 have been labeled with the same reference characters as used above to describe the exemplary embodiments of the LCD shown in FIG. 2, and any repetitive detailed description thereof will hereinafter be omitted.

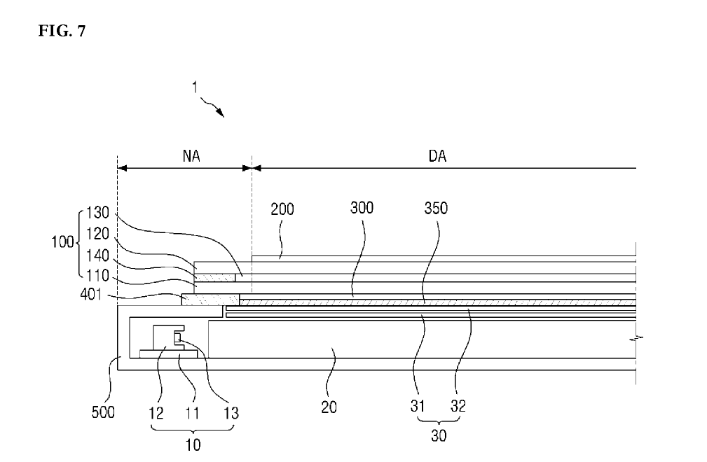

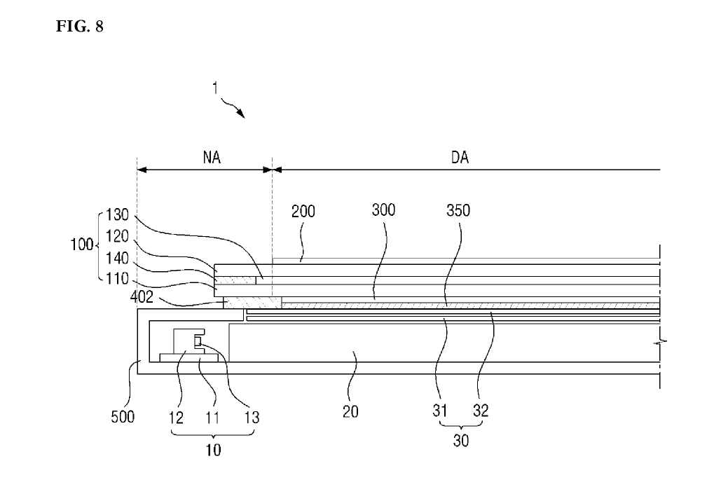

FIG. 7 is a cross-sectional view of an LCD 1 according to another alternative exemplary embodiment of the invention, taken along line I1-I1′ of FIG. 1, and FIG. 8 is a cross-sectional view of an LCD 1 according to another alternative exemplary embodiment of the invention, taken along line I1-I1′ of FIG. 1.

Referring to FIG. 7, in an exemplary embodiment, a first silica aerogel layer 401 may be disposed to protrude beyond a liquid crystal panel 100. In such an embodiment, the first silica aerogel layer 401 may extend further from a first substrate 110 of the liquid crystal panel 100. The liquid crystal panel 100 may be secured on or supported by a portion of a supporting surface of a bottom chassis 500, and the first silica aerogel layer 401 may have a larger contact area with the bottom chassis 500 than the overlapping area of the liquid crystal panel 100 and the supporting surface of the bottom chassis 500. However, the invention is not limited to this. In an alternative exemplary embodiment, as illustrated in FIG. 8, a first silica aerogel layer 402 may have a smaller contact area with a bottom chassis 500 than the overlapping area of a liquid crystal panel 100 and a supporting surface of the bottom chassis 500, and may be disposed along the boundary between a display area DA and a non-display area NA to extend beyond the non-display area NA. The same or like elements shown in FIGS. 7 and 8 have been labeled with the same reference characters as used above to describe the exemplary embodiments of the LCD shown in FIG. 2, and any repetitive detailed description thereof will hereinafter be omitted.

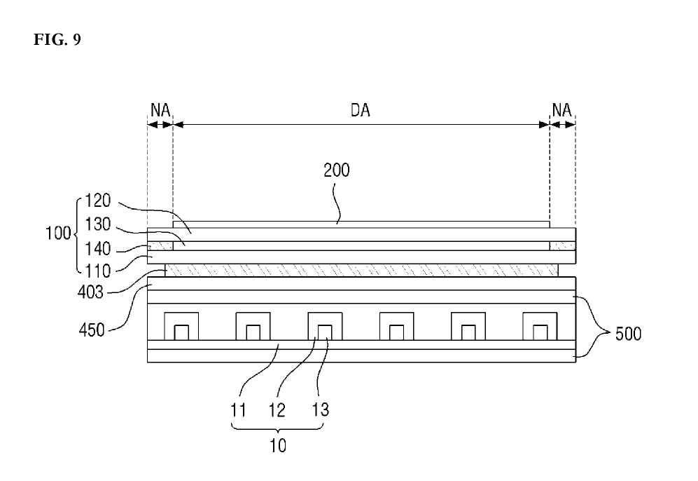

FIG. 9 is a cross-sectional view of an LCD according to another alternative exemplary embodiment of the invention, taken along line I2-I2′ of FIG. 1. Referring to FIG. 9, in an exemplary embodiment, a first silica aerogel layer 403 may be partially recessed toward the inside of a liquid crystal panel 100. In such an embodiment, the first silica aerogel layer 403 may have a smaller width than the width of first and second substrates 110 and 120 of the liquid crystal panel 100. In such an embodiment, where the first silica aerogel layer 403 has a smaller width than the width of the first and second substrates 110 and 120 of the liquid crystal panel 100, the first silica aerogel layer 403 may completely cover a light source 10. The same or like elements shown in FIG. 9 have been labeled with the same reference characters as used above to describe the exemplary embodiments of the LCD shown in FIG. 3, and any repetitive detailed description thereof will hereinafter be omitted.

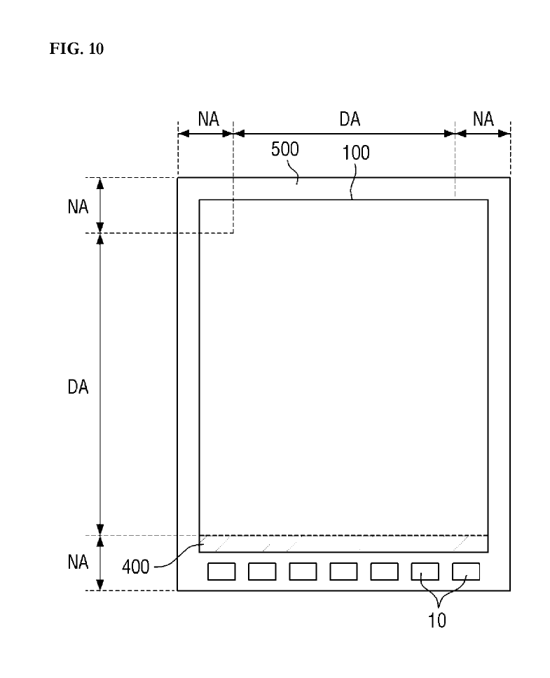

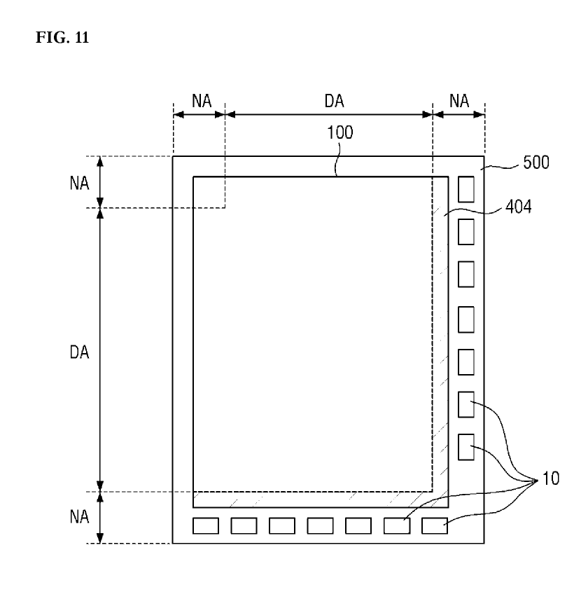

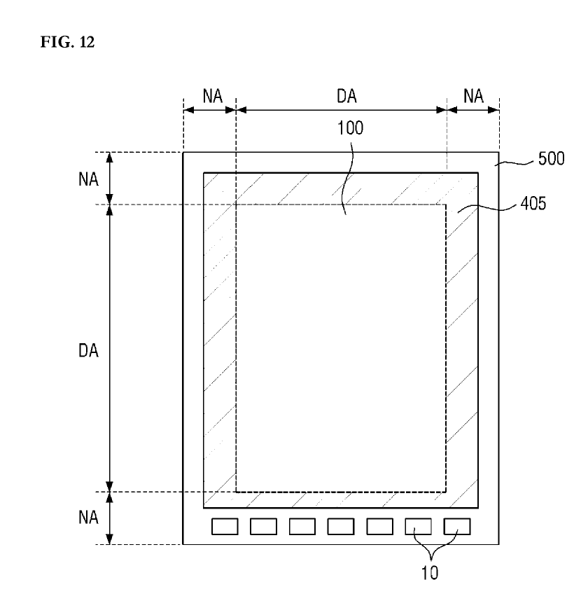

FIG. 10 is a plan view of the LCD 1 of FIG. 1, FIG. 11 is a plan view of an LCD according to another alternative exemplary embodiment of the invention, and FIG. 12 is a plan view of an LCD according to another alternative exemplary embodiment of the invention. That is, FIGS. 10 to 12 illustrate the arrangement of one or more light sources and a first silica aerogel layer in LCDs according to various exemplary embodiments of the invention.

Referring to FIG. 10, in an exemplary embodiment, a plurality of light sources 10 may be arranged in a first direction along one side (e.g., a short side) of a liquid crystal panel, and a first silica aerogel layer 400 may be disposed in the first direction to overlap a non-display area NA of the liquid crystal panel 100. Accordingly, the transmission of heat to the liquid crystal panel 100 along the first path P1, as described above with reference to FIG. 2, may be blocked.

Referring to FIG. 11, in an alternative exemplary embodiment, a plurality of light sources 10 are disposed along two sides (e.g., one long side and one short side) of a liquid crystal panel 100, and a first silica aerogel layer 404 may be disposed in a non-display area NA of the liquid crystal panel 100 to correspond to the light sources 10. However, the location of the first silica aerogel layer 404 is not necessarily limited to a region corresponding to the light sources 10. In an alternative exemplary embodiment, as illustrated in FIG. 12, where a plurality of light sources 10 is arranged along only one side of a liquid crystal panel 100, a first silica aerogel layer 405 may be disposed along all the sides of the liquid crystal panel 100.

According to exemplary embodiments of the invention, although not specifically illustrated, an LCD may further include a bottom cover, which covers a bottom chassis from outside the bottom chassis, a window, which covers the top of a liquid crystal panel, and a top chassis, which has an opening through which a display area of the liquid crystal panel is exposed, and may also include a heat dissipation member, which is disposed between the bottom chassis and the bottom cover. Such elements of the LCD are already well known in the art to which the invention pertains, and thus, detailed descriptions thereof will be omitted.

Hereinafter, an exemplary embodiment of a method of manufacturing an LCD, will hereinafter be described with reference to FIGS. 1 to 5. Referring to FIGS. 1 to 5, an exemplary embodiment of the method of manufacturing an LCD includes preparing the light source 10, the bottom chassis 500, and the liquid crystal panel 100, disposing the light source 10 in the bottom chassis 500, and disposing the liquid crystal panel 100 on the bottom chassis 500 with the first silica aerogel layer 400 interposed between the bottom chassis 500 and the liquid crystal panel 100.

As described above, the bottom chassis 500 may include a bottom surface, sidewalls, which extend upwardly from the sides of the bottom surface, and a supporting surface, which is parallel to the bottom surface, and the light source 10 may be disposed, e.g., inserted, between the bottom surface and the supporting surface of the bottom chassis 500. The first silica aerogel layer 500 may be located between the top of the supporting surface of the bottom chassis 500 and the liquid crystal panel 100.

The method may further include disposing the upper polarizing plate 200 on the liquid crystal panel 100, disposing the lower polarizing plate 300 below the liquid crystal panel 100, and forming the second silica aerogel layer 350 on at least a portion of an outer surface of the lower polarizing plate 300.

The second silica aerogel layer 350 may be provided or formed when the lower polarizing plate 300 is already attached onto the liquid crystal panel 100, but the invention is not limited thereto. That is, the lower polarizing plate 300 may be fabricated in advance, and may be attached onto the liquid crystal panel 100 after the formation of the second silica aerogel layer 350 on the lower polarizing plate 300.

The second silica aerogel layer 350 may be formed by a sol-gel reaction between MATS and TEOS. In an exemplary embodiment, a sol-gel reaction between MATS and TEOS may be induced to form nanoparticles, and the nano-particles may be aged at a temperature in a range of about 40° C.. to about 60° C.. and may then be subjected to supercritical drying at a temperature of about 35° C.. at a pressure of about 100 bar, thereby obtaining a hybrid silica aerogel with a methacrylate functional group introduced thereinto. The hybrid silica aerogel may be represented by the following Formula:

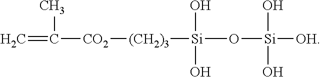

The hybrid silica aerogel may be dispersed in an isopropyl alcohol at a ratio of about 1:10, and a urethane acrylic oligomer and methyl methacrylate are added to the hybrid silica aerogel. Thereafter, a photo-initiator is added in the amount in a range of about 1:10, to about 10% by weight, thereby obtaining a raw material for forming the second silica aerogel layer 350.

The raw material may be applied on an outer surface of the lower polarizing plate through bar coating or slit coating, and UV light may be irradiated onto the raw material, thereby forming the second silica aerogel layer 350.

In such an embodiment, the second silica aerogel layer 350 may include a UV-curable resin and a photo-initiator in addition to a hybrid silica aerogel, and may thus be formed through coating or UV irradiation. The second silica aerogel layer 350 may include an acrylic resin as the UV-curable resin. In one exemplary embodiment, for example, the second silica aerogel layer 350 may include a hybrid silica aerogel with an acrylate functional group having high miscibility, and may thus have high light transmittance.

Although some embodiments of the invention have been described for illustrative purposes, those skilled in the art will appreciate that various modifications, additions and substitutions are possible, without departing from the scope and spirit of the invention as disclosed in the accompanying claims.

What is claimed is:

1. A liquid crystal display, comprising:
a light source;
a liquid crystal panel comprising first and second substrates, which face each other, and liquid crystals interposed between the first and second substrates;
a bottom chassis which supports the liquid crystal panel, wherein the light source is disposed in the bottom chassis; and
a first silica aerogel layer disposed between the liquid crystal panel and the bottom chassis.

2. The liquid crystal display of claim 1, wherein the light source comprises a light-emitting diode.

3. The liquid crystal display of claim 1, wherein the light source and the first silica aerogel layer overlap each other.

4. The liquid crystal display of claim 1, wherein
the liquid crystal panel includes a display area and a non-display area, and
at least a portion of the first silica aerogel layer is disposed in the non-display area of the liquid crystal panel.

5. The liquid crystal display of claim 1, wherein the liquid crystal panel and the bottom chassis are attached to each other by the first silica aerogel layer.

6. The liquid crystal display of claim 1, wherein
the bottom chassis includes a bottom surface, sidewalls, which extend upwardly from sides of the bottom surface, and a supporting surface, which is parallel to the bottom surface, and
the light source is disposed between the bottom surface and the supporting surface of the bottom chassis.

7. The liquid crystal display of claim 6, wherein the first silica aerogel layer is disposed between the supporting surface of the bottom chassis and the liquid crystal panel.

8. The liquid crystal display of claim 1, further comprising:
an upper polarizing plate disposed on the liquid crystal panel;
a lower polarizing plate disposed below the liquid crystal panel; and
a second silica aerogel layer disposed on at least a portion of an outer surface of the lower polarizing plate.

9. The liquid crystal display of claim 8, wherein the second silica aerogel layer has a light transmittance of about 80% or higher.

10. The liquid crystal display of claim 8, wherein the second silica aerogel layer comprises an ultraviolet-cured resin.

11. The liquid crystal display of claim 10, wherein the ultraviolet-cured resin comprises an acrylic functional group.

12. The liquid crystal display of claim 11, wherein the second silica aerogel layer further comprises a hybrid silica aerogel represented by the following formula:

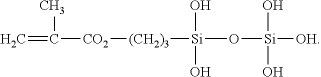

13. The liquid crystal display of claim 8, wherein the first silica aerogel layer does not overlap the lower polarizing plate.

14. A method of manufacturing a liquid crystal display, the method comprising:
preparing a light source, a bottom chassis and a liquid crystal panel of the liquid crystal display;
disposing a light source of the liquid crystal display on the bottom chassis; and
disposing the liquid crystal panel on the bottom chassis; and
providing a first silica aerogel layer between the bottom chassis and the liquid crystal panel.

15. The method of claim 14, wherein
the bottom chassis includes a bottom surface, sidewalls, which extend upwardly from the sides of the bottom surface, and a supporting surface, which is parallel to the bottom surface, and
the disposing the light source of the liquid crystal display on the bottom chassis comprises inserting the light source between the bottom surface and the supporting surface of the chassis.

16. The method of claim 15, wherein the providing the first silica aerogel layer between the bottom chassis and the liquid crystal panel comprises disposing the first silica aerogel layer between the top of the supporting surface of the chassis and the liquid crystal panel.

17. The method of claim 14, further comprising:
providing an upper polarizing plate on the liquid crystal panel;
providing a lower polarizing plate below the liquid crystal panel; and
forming a second silica aerogel layer on at least a portion of an outer surface of the lower polarizing plate.

18. The method of claim 17, wherein the forming the second silica aerogel layer comprises forming the second silica aerogel layer through a sol-gel reaction between 3-methacryl trimethoxysilane and tetraethyl orthosilicate.

19. The method of claim 18, wherein
the second silica aerogel layer comprises a hybrid silica aerogel obtained by the sol-gel reaction, and
the hybrid silica aerogel is represented by the following formula:

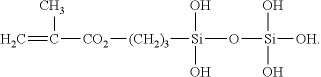

20. The method of claim 19, wherein the forming the second silica aerogel layer further comprises using an ultraviolet-curable resin and a photo-initiator.
